(19) United States
(12) Patent Application Publication
(10) Pub. No.: US 2025/0128129 A1
(43) Pub. Date: Apr. 24, 2025

(54) GOLF CLUB HEAD AND DESIGN OPTIMIZATION

(71) Applicant: James MILLER, Scottsdale, AZ (US)

(72) Inventor: James MILLER, Scottsdale, AZ (US)

(21) Appl. No.: 18/718,755

(22) PCT Filed: Dec. 12, 2022
(86) PCT No.: PCT/US2022/052599

§ 371 Date: Nov. 25, 2024

Related U.S. Application Data
(60) Provisional application No. 63/288,576, filed on Dec. 11, 2021.

(51) Int. Cl. A63B 53/04; A63B 60/50; A63B 102/32; B33Y 80/00

(52) U.S. Cl. CPC A63B 53/042; A63B 53/0466; A63B 60/50; B33Y 80/00; A63B 2102/32

(57) ABSTRACT

A club head for a golf club is provided. The club head is topologically optimized so that, when manufactured by additive manufacturing processes from an optimized design, the club head performs substantially the same functions as a version of the club head manufactured from an initial object design. The optimization may be constrained by design requirements that the corresponding club head fabricated by AM processes must satisfy. A system for topologically optimizing a design of a golf club head includes device logic to apply an iterative optimization process to transform an initial design of a club head into an optimized design. The design requirements may be represented by one or more input vectors that may be stored in memory and/or generated from input data provided via the interface. The processor may store the optimized design and/or may export the optimized design to another system, such as an additive manufacturing device.

### CROSS-REFERENCE TO RELATED APPLICATION

This is the international application claiming the benefit of priority from U.S. Prov. Pat. App. Ser. No. 63/288,576, filed under same title on Dec. 11, 2021, and incorporated fully herein by reference.

### FIELD OF INVENTION

This invention relates to golf clubs, and more particularly to golf club head designs that are optimized for additive manufacturing processes.

### BACKGROUND

Conventionally, golf clubs are designed for appearance, pendular properties, and performance with respect to the type of club and the physical characteristics and playing style of the player. Golf clubs are made of particular materials to particular specifications to achieve particular design goals; standards-setting organizations for managing competitive golf also set rules that constrain design specifications. Over time, golf clubs have evolved from simple striking implements to highly-engineered devices exhibiting construction from performance materials, complex contours of the club head, and precise customization matching club design to paying customer.

Additive manufacturing (AM) processes are processes for fabricating parts through material addition. Specifically, AM devices manufacture three-dimensional objects by adding layer-upon-layer of material in the “build direction” (e.g., from the bottom to the top of the object). The growing interest in AM stems from its ability to fabricate highly complex parts, including metal parts, with relative ease. This has led to computational modeling of parts in order to optimize the design for AM processes and thus fabricate parts which may be more complex than the original part, but uses or wastes less material and performs the same functions with lower weight, smaller footprint, etc. In some instances, optimizing the design may even provide greater strength, more aerodynamic, tuning, customization or other features which may change the performance or distinguish one product from another in the marketplace.

In one example, topology optimization (TO) represents a class of computational methods for designing lightweight, high-performance structures. After several years of intensive research, it has emerged as a powerful design tool, and is deployed in optimization of aircraft components, spacecraft modules, automobile components, cast components, compliant mechanisms, etc. The overarching goal of TO is to start with a given design that meets specifications for rigidity, load bearing, force resistance, etc., and reduce it to an optimized design that is lighter in weight and uses the least amount of material while meeting or exceeding concomitant specifications. Designs stemming from TO are geometrically complex, and therefore hard to manufacture using traditional processes, but these designs can often be additively manufactured. Also, since fabrication cost in AM is proportional to the material used, light-weight topology optimized designs are particularly relevant in AM.

As described in this disclosure, advances in metal component manufacturing and associated computer-implemented optimization can advantageously be applied to golf club designs to produce golf clubs that match or exceed the performance of existing clubs, and also exhibit improvements in pre-fab customization, manufacturing flexibility, material consumption, aerodynamics, range and accuracy performance, and adaptability during play.

### SUMMARY

The present invention utilizes recent developments in manufacturing technology and structural design optimization in conjunction with novel concepts and assemblies embodied in golf clubs and golf club heads. It is an object of the invention to provide a golf club head that is computationally optimized for fabrication using metal additive manufacturing processes yet satisfies predetermined performance characteristics common to the type and/or grade of club. A further object is to provide an “organic” or “skeletal” structure of the club head, which can reduce material consumption during manufacture, and/or provide benefits to the player with respect to club weight, weight balance, aerodynamics, tunability, user feedback, distance, control and accuracy, etc. It is another object of the invention to provide a fully tunable club by way of torsion, weight, and in-play adjustment. A further object is to provide a framework by which to add or reduce weight in one or more areas of the club. Another object is to incorporate or provide a unique and adjustable club face. Another object is to provide embodiments of the invention that may or may not satisfy the equipment rules and conformity standards of professional golf associations that may currently exist with such organizations as the USGA.

### BRIEF DESCRIPTION OF THE DRAWINGS

The invention will be better understood from a reading of the following detailed description taken in conjunction with the drawings in which like reference designators are used to designate like elements, and in which:

FIG. 1 is a front view of an example embodiment of a computationally optimized golf club head, in accordance with the present disclosure;

FIG. 2 is a top perspective view of another example embodiment of a computationally optimized golf club head, in accordance with the present disclosure;

FIG. 3 is a cross-sectional front view of another example embodiment of a computationally optimized golf club head, in accordance with the present disclosure;

FIG. 4 is a side view of another example embodiment of a computationally optimized golf club head, in accordance with the present disclosure;

FIG. 5 is a top view of another example embodiment of a computationally optimized golf club head, in accordance with the present disclosure;

FIG. 6 is a cross-sectional side view of another example embodiment of a computationally optimized golf club head, in accordance with the present disclosure; and

FIG. 7 is a diagram of an example system configured to transform an initial design and a set of performance targets into an optimized design according to a topological optimization framework, in accordance with the present disclosure.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

This disclosure presents structural designs and design concepts, methods of manufacture, and methods of computer-implemented design optimization, for golf clubs and golf club heads that have a distinctive “organic” or “skeletal” structure commonly seen in objects that are topologically optimized for certain manufacturing processes, including but not limited to any form of current or future additive manufacturing. This disclosure provides embodiments of an optimization process, and corresponding golf clubs that are products of the process; in some embodiments the optimization process can receive inputs, such as an initial club head design and a set of target parameters, and can iterate a topological optimization of the initial design to produce a plurality of iterative designs including a final optimized design that satisfies the requirements of the target parameters. The target parameters can include, but are not limited to: a target reduction of the amount of material needed for manufacture; physical characteristics such as weight, shape, conformance, material composition; performance characteristics common or desirable to golf clubs (e.g., distance, accuracy, speed of club head); aesthetic requirements or objectives; standards-based design requirements; compatibility with club faces and tuning mechanisms, such as those described herein; and, the like. The example embodiments of the Figures include optimized drivers and irons, but in various embodiments the invention is suitable for producing an optimized version of any conventional type of golf club, including without limitation drivers, woods, irons, hybrids, wedges, and putters.

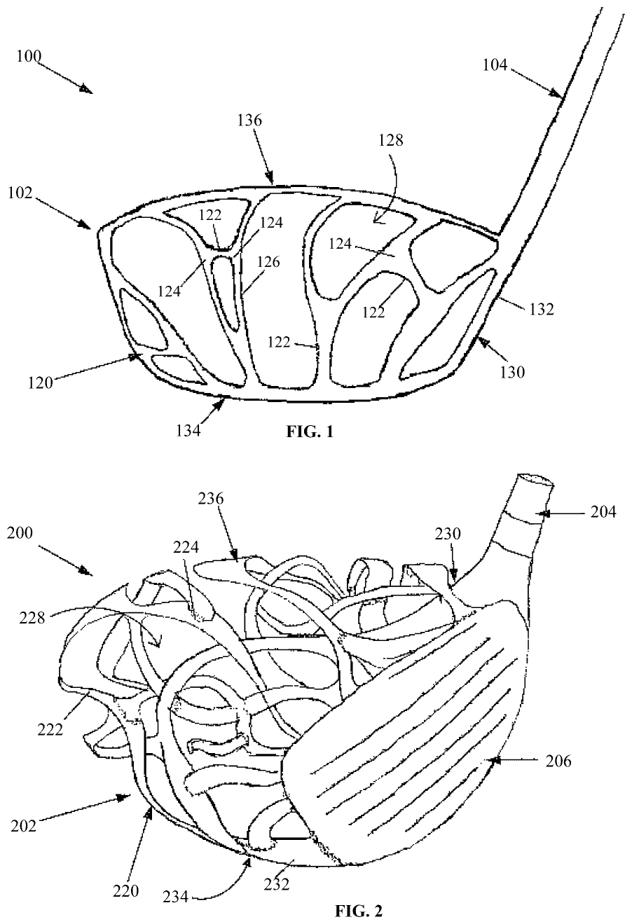

FIG. 1 illustrates an example embodiment of the inventive apparatus, generally designated as 100, which is a design for a golf club having computationally optimized components. Generally, the design 100 for the golf club may include a club head 102 and a shaft 104 attached to or integral with club head 102. In various embodiments, one or both of the club head 102 and shaft 104 (or portion thereof) may be optimized for additive manufacturing, casting, or another suitable manufacturing method, as described herein; additionally, it will be understood that an optimized design such as design 100, which is based on an initial design and a set of target parameters as described herein, may exhibit dramatic topological differences from the initial design but in some cases can be visually similar to the initial design, depending on the optimization algorithm used and the constraints thereon.

The club head 102 includes a body 120 that includes the structural members of the club head, and defines the shape, size, and outer surface contours of the club head. The design of the body 120 is produced by the optimization algorithm as the optimal solution for satisfying the input constraints; in various embodiments, including the illustrated example, the body 120 may exhibit significant topological optimizations relative to the initial design. Any optimization algorithm suitable for optimizing a solid object for additive manufacturing may be applied to produce the body 120 design. In some embodiments, for example, a lattice structure design optimization may be used to replace the solid structures of the club head with lattice structure. This disclosure adopts lattice structure terminology to identify structural members of the inventive designs, without limiting the applicability of other algorithms that are not based on lattice structures. Structures are also described as “organic” or “skeletal” to refer to the distinctive appearance of topologically optimized designs; these terms are used herein according to their common understanding, but do not limit the characteristics of the design components.

Thus, the body 120 topology is comprised of an arrangement of linking members, or “linkers” 122, that are composed of the manufacturing material and that are attached to or integral with other linkers 122 at the points of intersection, or “nodes” 124. Linkers 122 may have uniform dimensions or may vary in length, thickness, angle and/or curvature, density, etc., and may be made of the same or different “materials” which may exhibit, augment or append different and/or desirable end product characteristics. In some embodiments, the linkers 122 may comprise a metal or metallic composite that can be dispersed by additive manufacturing processes or other forms of deposition. Furthermore, the material may be a performance material suitable for use in the golf industry. The linkers 122 may be solid structures, or tubes with a uniform or varying wall thickness, or a combination thereof. The body 120 design includes a frame 130 that defines the boundaries of the body 120. The frame is comprised of frame members 132 that are composed of one or more manufacturing materials and that define each of the outer surfaces and common exterior structures of the club head 102, such as the bottom surface 134 that opposes the ground when the club is swung, the top surface 136 that defines the crown of the club head 102, the “heel” and “toe” of the club head 102, and so on. In some embodiments, the frame members 132 may be linkers in the lattice structure; the body 120 may accordingly be a conformal lattice that constrains the frame members 132 so that the frame 130 maintains a desired shape of the club head 102.

In some embodiments, the body 120 may include other elements that contribute to the improved characteristics of the golf club design 100. For example, the lattice of the body 120 may include one or more struts 126, which is a linker or a series of integral linkers 122 that extends between two frame members 132 to provide structural support for the club head 102. The body 120 may also include one or more voids 128 comprising the empty space between linkers 122 within the bounds of the frame 130. In some embodiments, one or more of the voids 128 may extend through the perimeter of the club head 102 at one or more points, creating a visible cavity or even a complete passage from one side of the club head 102 to another. Voids 128 may be designed to contribute to features of the golf club, including without limitation: to impart desired aesthetic elements; to provide aerodynamic benefits; to aid in swing control; or, to produce feedback for the player, such as an audible sound produced at a particular pitch when air passes into/through the voids 128 during a swing.

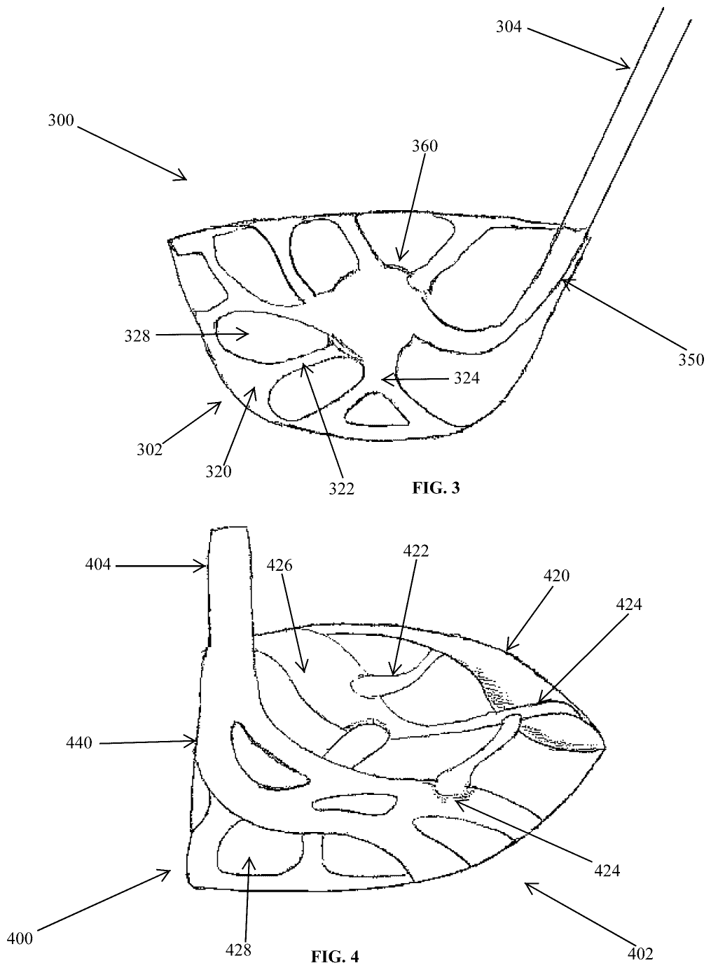

FIG. 2 illustrates another example embodiment of a design 200 for the present golf club. A club head 202 and shaft 204 are provided as described above, including a body 220 of the club head 202 that is optimized for additive or other manufacturing processes, systems or techniques and includes linkers 222, nodes 224, one or more struts 226, and one or more voids 228. Further shown is a frame 230 comprising frame members 232 that define bottom and top surfaces 234, 236 and other exterior features of the golf club as described above. The illustrated view of the design 200 further shows the face 206 of the club head 202, which is the ball-striking surface of the golf club. The face 206 may be planar, concave, or convex surface, and may comprise grooves or other surface structures. In some embodiments, the face 206 may be constructed according to rules and regulations of the USGA or another standards-setting organization for the game of golf. The face 206 may be defined by a structure that is attached to or integral with the body 220. For example, where the club head 202 is fabricated by additive manufacturing or similar deposition processes, the structure defining the face 206 may be included in the fabricated design, and “printed” along with the linkers 222 of the body 220. In another example where the club head 202 is manufactured by casting, the face 206 structure may be defined in the mold for the club head 202, or alternatively may be separately cast and attached to the body 220 after casting.

FIG. 3 illustrates another example embodiment of a design 300 for the present golf club. A club head 302 and shaft 304 are provided as described above, including a body 320 of the club head 302 that is optimized for additive manufacturing and includes linkers 322, nodes 324, and voids 328. The illustrated view of the design 300 further shows structures of the body 320 that are modeled based on additional support constraints. For example, one or more of the linkers may be a shaft support linker 350 that forms or connects to a shaft mount of the club head 302 where the shaft 304 is inserted. In some embodiments, the shaft support linker 350 may have a hook-like shape that begins where the shaft 304 is inserted and loops around the back of the club head 302 and wraps forward on the opposite/outer side of the club head 302 to provide more “tunable” isolation from other linkers 322 that support the club face and thus provide more variety for “tuning” the club/face to the individual's preferences. Further, one or more of the linkers may be a face support linker 360 that has a relatively wide diameter at one end, at which end the face support linker 360 intersects the structure that defines the club face. In some embodiments, the wide end of the face support linker 360 may be substantially planar, providing a mounting surface for attaching the club face to the club head 302.

FIG. 4 illustrates another example embodiment of a design 400 for the present golf club. A club head 402 and shaft 404 are provided as described above, including a body 420 of the club head 402 that is optimized for additive manufacturing and includes linkers 422, nodes 424, and voids 428. The illustrated view of the design 400 further shows structures of the body 420 that are modeled based on additional support constraints. For example, one or more of the linkers 422 may form a club face 440 that may serve as the ball-striking surface or may attach to a separate club face for striking the ball. In some embodiments, the wide end of the linker(s) 422 forming the club face 440 may be substantially planar, providing a mounting surface for attaching a separate club face attachment to the club head 402. In addition, one or more of the linkers may be a shaft support linker 450 that forms or connects to a shaft mount of the club head 402 where the shaft 404 is inserted. In some embodiments, the shaft support linker 350 may be integral with the shaft 404.

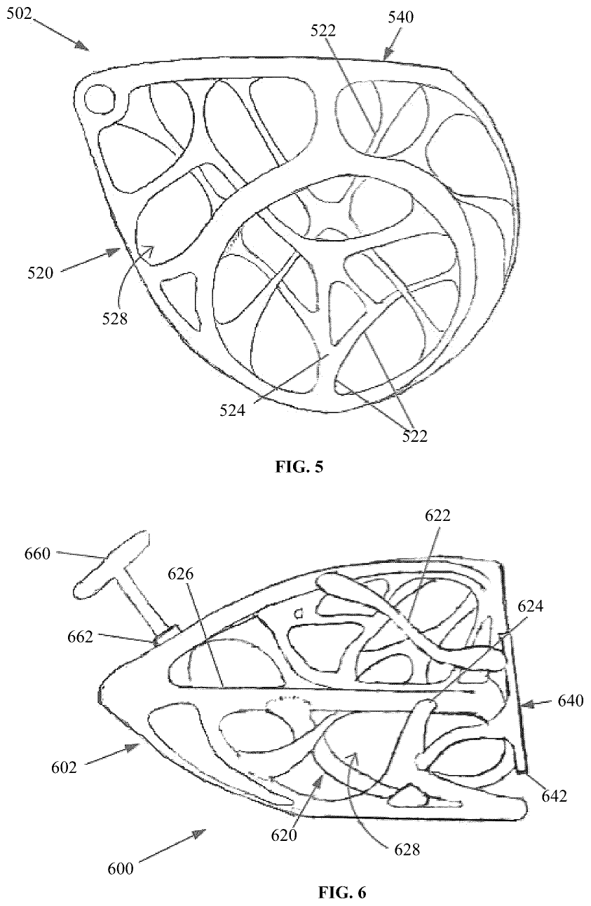

FIG. 5 illustrates another example embodiment of a club head 502 as described with respect to FIGS. 3 and 4. A body 520 of the club head 502 is optimized for additive manufacturing and includes linkers 522, nodes 524, and voids 528. One or more of the linkers 522 may form a club face 540 that may serve as the ball-striking surface or may attach to a separate club face for striking the ball. In some embodiments, the wide end of the linker(s) 522 forming the club face 540 may be substantially planar, providing a mounting surface for attaching a separate club face attachment to the club head 502.

FIG. 6 illustrates another example embodiment of a design 600 for the present golf club. A club head 602 and shaft 604 are provided as described above, including a body 620 of the club head 602 that is optimized for additive manufacturing and includes linkers 622, nodes 624, strut(s) 626, and voids 628. The illustrated view of the design 600 further shows the club face 640 defined by a panel 642 that is attached to or integral with one or more of the linkers of the body 620. For example, one of the linkers may be a face support linker 626 as described above with respect to FIG. 3, and may in some embodiments extend from the face rearward to the toe of the club head 602 in an axial fashion, providing support at or near the “sweet spot” of the club face 640. In some embodiments, one or more of the linkers 622 may be composed under adjustable tension, the force of which may be modified by actuating a tuning mechanism. For example, the club head 602 may comprise one or more tuning ports 662 that receive a tuning key 660; turning the tuning key 660 may adjust various forces on one or more components of the club head 602, which in turn may affect the performance and playability of the club-including but not limited to; the overall structural rigidity and the torsion, shear, strain, and other forces, as well as the magnitude and direction of force applied, on the body 620 and/or club face 640. There may be a plurality of tuning ports each attached to one or more particular components of the club head 602.

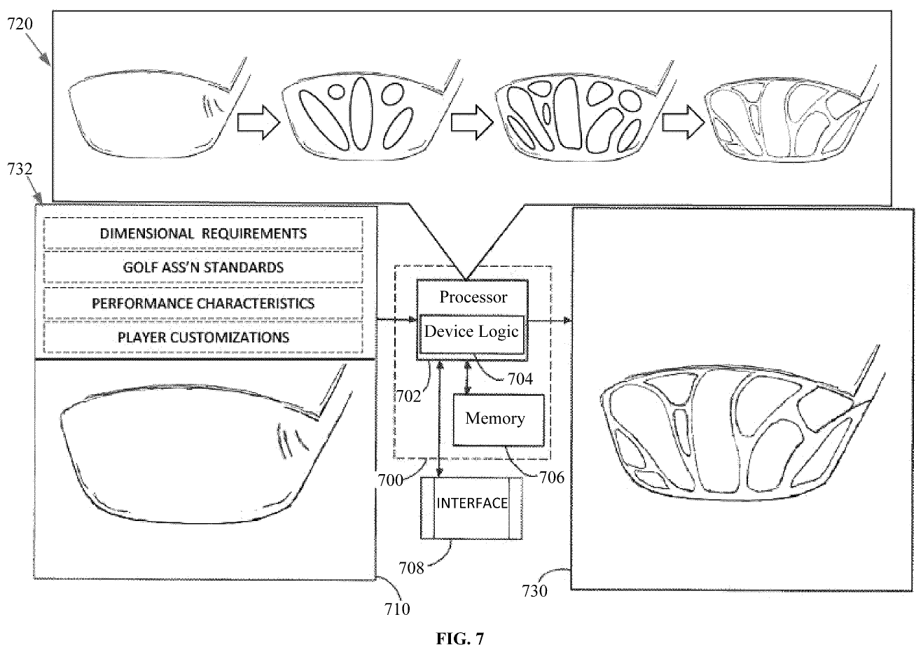

FIG. 7 illustrates an exemplary system for optimizing a design of an object according to a support volume sensitive TO framework. A computing device 700 includes a processor 702 that executes device logic 704 within the processor 702 or contained in memory 706 of the computing device 700. The device logic 704 configures the processor 702 to perform the processes described herein. The computing device 700 may be a server computer or a system of interconnected server computers, such as a web server, application server, application platform, virtual server, cloud data server, and the like, or a personal computer, laptop computer, tablet computer, e-reader, smartphone, personal data assistant, microconsole, industrial automation system, or similar computing device having, as the processor 702, a central processing unit (CPU), microprocessor, or other suitable processor. In some embodiments, the device logic 704 and/or memory 706 may store program instructions and other data for a computer-aided drafting (CAD) program, or another suitable program, for creating, modifying, exporting, and performing other processes on data (e.g., files, database records, data streams, etc.) representing two- and/or three-dimensional designs of objects that can be fabricated by AM processes. The program instructions and other data for performing the processes herein may cooperate with the CAD program.

The processor 702 receives, as input, an initial object design 710. The initial object design 710 may be input by a user of an interface 708, which may be presented to a user on the computing device 700 or on another device, such as a drafting computer. The interface 708 may be presented on a display of the user device via a dedicated software application (e.g., a CAD program), an internet browser or other web application, or another suitable application in which the interface 708 is a component, such as in a web dashboard or other administration tool. In some embodiments, the interface 708 may be configured to prompt the user to provide the initial object design 710 and may present and facilitate one or more options for doing so. For example, the interface 708 may prompt the user to select a file for upload. The interface 708 may further prompt the user to enter other data used in the present processes, such as the desired performance characteristics, the physical dimensions of a player, swing analysis data, and the like.

The processor 702 executes the device logic 704 to apply an iterative optimization process 720 to transform the initial object design 710 into an optimized design 730. The optimized design 730 is topologically optimized for performance, i.e., an object manufactured by AM processes from the optimized design 730 performs substantially the same functions as an object manufactured from the initial object design 710. The optimization may further be constrained by design requirements that the corresponding object fabricated by AM processes must satisfy. The design requirements may be represented by one or more input vectors 732 that may be stored in memory 706 and/or generated from input data provided via the interface 708. The processor 702 may store the optimized design 730 (and any intermediate designs), such as in memory 706, and/or may export the optimized design 730 to another system, such as an AM device.

While various embodiments of the present invention have been illustrated and described in detail, it should be apparent that modifications and adaptations to those embodiments may occur to one skilled in the art without departing from the scope and spirit of the present invention.

What is claimed is:

1. A golf club head comprising a body that is topologically optimized, relative to an initial design of the body, to perform substantially similarly to the initial design and to also satisfy a set of input constraints.

2. The golf club head of claim 1, wherein a lattice structure design optimization is used to replace solid structures in the initial design of the body with lattice structure.

3. The golf club head of claim 2, wherein the lattice structure is a conformal lattice constrained by a frame that defines the boundaries of the body.

4. The golf club head of claim 1, wherein the body is comprised of an arrangement of linking members composed of a manufacturing material and intersecting with each other at corresponding nodes within the body.

5. The golf club head of claim 4, wherein the manufacturing material comprises a metal or metallic composite that can be dispersed by additive manufacturing processes.

6. The golf club head of claim 4, wherein the linking members vary in length, thickness, angle, and curvature.

7. The golf club head of claim 4, wherein the linking members include a plurality of frame members that define outer surfaces of the body.

8. The golf club head of claim 7, wherein the linking members further include one or more struts each extending between two of the plurality of frame members to provide structural support for the golf club head.

9. The golf club head of claim 4, wherein the linking members include a shaft support member that connects to a shaft mount of the golf club head 302 where a shaft is inserted.

10. The golf club head of claim 9, wherein the shaft support member has a hook-like shape that begins where the shaft is inserted and wraps around a rear of the golf club head and extends forward on an outer side of the body to provide tunable isolation from other linking members that support a face of the golf club head.

11. The golf club head of claim 4, wherein the linking members include a face support member positioned to provide support at or near a “sweet spot” of a face of the golf club head.

12. The golf club head of claim 11, wherein the face support member extending from the face rearward to a toe of the club head in an axial fashion.

13. The golf club head of claim 4, wherein one or more of the linking members may be disposed under adjustable tension, the golf club head further comprising a tuning mechanism mechanically connected to the one or more linking members to modify an amount of the tension.

14. The golf club head of claim 13, wherein the tuning mechanism comprises one or more tuning ports that receive a tuning key, and wherein turning the tuning key adjust various forces on one or more components of the golf club head.

15. The golf club head of claim 4, wherein the body further comprises one or more voids defined by empty space between linking members within the body.

16. The golf club head of claim 15, wherein one or more of the one or more voids extends through a perimeter of the body at one or more points.

17. The golf club head of claim 15, wherein the one or more voids are configured so that air passing into or through the voids during a swing produces an audible sound at a particular pitch that serves as feedback to a player.

18. The golf club head of claim 4, further comprising a face that includes a ball-striking surface, the face being integral with the body.

19. The golf club head of claim 18, wherein the face comprises one or more of the linking members.

20. The golf club head of claim 4, further comprising a face that includes a ball-striking surface, the face being attached to the body subsequent to manufacturing of the linking members.

21. The golf club head of claim 20, wherein the linking members include a face support member having a substantially planar mounting surface for attaching the face to the body.
